(19) United States
(12) Patent Application Publication
(10) Pub. No.: US 2008/0246289 A1
(43) Pub. Date: Oct. 9, 2008

(54) VEHICLE RADIATOR GUARD AND METHOD OF FABRICATING THE SAME

(76) Inventors: Russell Dale Skinner, Sikeston, MO (US); Edward Eugene Clayton, Sikeston, MO (US)

Correspondence Address: Robert B. Reeser III;Armstrong Teasdale LLP, Suite 2600, One Metropolitan Square, St. Louis, MO, 63102, US

(21) Appl. No.: 11/697,043

(22) Filed: Apr. 5, 2007

(51) Int. Cl. B60R 19/52

(52) U.S. Cl. 293/115; 180/68.6

(57) ABSTRACT

A radiator guard assembly for a vehicle that includes a first frame rail, a second frame rail, a bumper assembly coupled to the first and second frame rails, and a radiator coupled to the first and second frame rails is provided. The radiator guard assembly includes a radiator guard, and a pair of mounting brackets for coupling the radiator guard to the first and second frame rails and axially downstream from the bumper. The radiator guard is configured to substantially prevent an object from undesirably contacting the radiator.

### BACKGROUND OF THE INVENTION

This invention relates generally to vehicle radiators, and more particularly to a guard installed on a vehicle to protect the radiator.

Heavy duty vehicles are often utilized to transport goods across various geographic locations. As such, known heavy duty vehicles often include an engine that is mounted to a chassis, and a cooling system that is utilized to reduce the operating temperature of the engine. More specifically, known heavy duty vehicles often include a cooling pump that circulates a cooling fluid through the engine to reduce the operating temperature of the engine. To facilitate removing heat from the cooling fluid, the cooling fluid is channeled through a heat exchanger or radiator which is generally mounted to the chassis and positioned near the front of the heavy duty vehicle. During operation, airflow is channeled through the radiator to facilitate reducing the operating temperature of the cooling fluid channeled therethrough.

As the new emissions laws are being written to require engine manufacturers to increase EGR levels, the heat load produced by the engine is also higher. These regulations now cause the truck manufacturer to provide sufficient cooling for the engine. Additionally, as the size and/or weight of the shipped goods has increased, additional strain has been placed on the cooling system to provide sufficient cooling for the engine. At least one known method of increasing the cooling capacity of the cooling system includes increasing the size of the radiator. For example, by increasing either the thickness, the width, or the height of the radiator. However, increasing the thickness or width of the radiator is often not practical since the radiator width is constrained by a distance defined between the front frame of the vehicle and the engine, and the radiator width is constrained by a dimension defined between the frame rails.

As a result, at least some known manufacturers have utilized a radiator that has an increased height to increase the cooling capacity. For example, since the placement of the radiator is also limited by the hood coupled to the vehicle, the height of the radiator is increased to a point that at least a portion of the radiator extends below a front bumper coupled to the vehicle. As such, during operation when the vehicle strikes a relatively heavy object, such as an animal for example, the front bumper may cause the animal to be driven under the front bumper thus striking that portion of the radiator that is extending below the front bumper. As a result, the radiator is subjected to an increased risk of damage that may be caused by objects striking the exposed portion of the radiator.

### BRIEF DESCRIPTION OF THE INVENTION

In one aspect, a radiator guard assembly for a vehicle that includes a first frame rail, a second frame rail, a bumper assembly coupled to the first and second frame rails, and a radiator coupled to the first and second frame rails is provided. The radiator guard assembly includes a radiator guard, and a pair of mounting brackets for coupling the radiator guard to the first and second frame rails and axially downstream from the bumper. The radiator guard is configured to substantially prevent an object from undesirably contacting the radiator.

In another aspect, a method for preventing damage to a vehicle radiator is provided. The method includes coupling a radiator guard to a first frame rail and a second frame rail such that radiator guard substantially covers at least a portion of the front and lower surface of the vehicle radiator to substantially prevent an object from undesirably contacting the radiator, and coupling a grill guard to the radiator guard.

In a further aspect, a vehicle is provided. The vehicle includes a first frame rail, a second frame rail, a bumper assembly coupled to the first and second frame rails, and a radiator coupled to the first and second frame rails. The radiator guard assembly includes a radiator guard, and a pair of mounting brackets for coupling the radiator guard to the first and second frame rails axially downstream from the bumper, the radiator guard configured to substantially prevent an object from undesirably contacting the radiator.

### BRIEF DESCRIPTION OF THE DRAWINGS

FIG. 1 is a perspective view of an exemplary vehicle that includes an exemplary radiator guard assembly;

FIG. 2 is an exploded view of a portion of the vehicle shown in FIG. 1;

FIG. 3 is a side view of the radiator guard assembly shown in FIGS. 1 and 2;

FIG. 4 is a perspective view of the radiator guard assembly shown in FIGS. 1 and 2;

FIG. 5 is an exploded view of a portion of the vehicle shown in FIG. 1 including another exemplary radiator guard assembly;

FIG. 6 is a side view of the radiator guard assembly shown in FIG. 5; and

FIG. 7 is a perspective view of the radiator guard assembly shown in FIGS. 5 and 6.

### DETAILED DESCRIPTION OF THE INVENTION

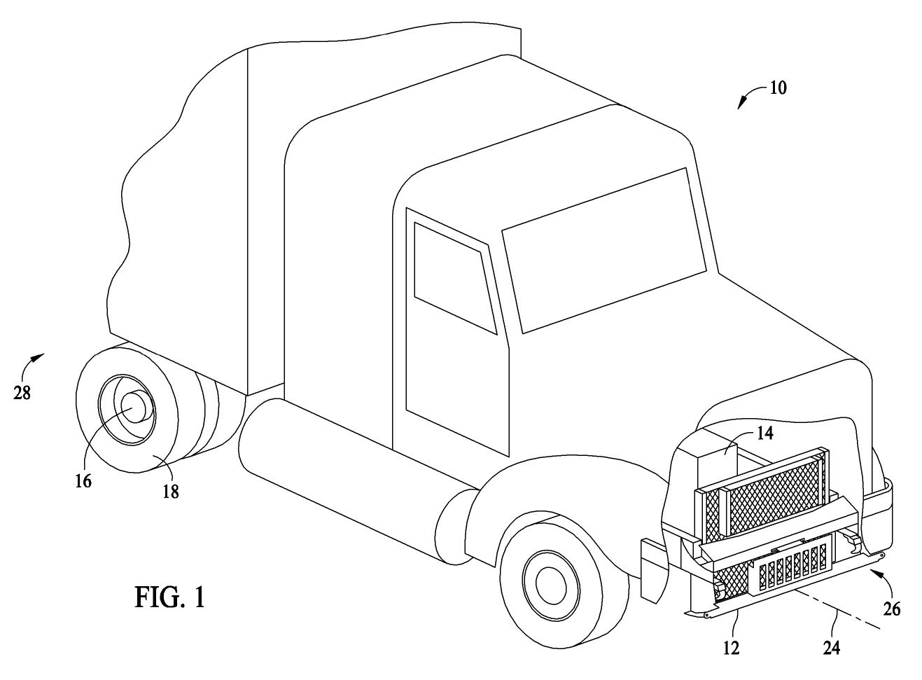

FIG. 1 is a perspective view of an exemplary vehicle 10 that includes an exemplary radiator guard assembly 12. Vehicle as used herein represents any of a broad class of apparatuses that may be utilized to move an operator and cargo from a first location to a second location, and may include for example, trucks, buses, automobiles, off-road vehicles, etc. Vehicle 10 includes an engine 14, a transmission (not shown) that is coupled to the engine 14, a differential 16, and at least one drive shaft (not shown) that is coupled between the transmission and differential 16. The vehicle 10 also includes at least two wheels 18 that are coupled to respective ends of the differential. In one embodiment, vehicle 10 is configured as a rear wheel drive vehicle such that the differential is positioned near the aft end of vehicle 10 and therefore configured to drive at least one of the wheels 18. Optionally, vehicle 10 may configured as a front wheel drive vehicle. In the exemplary embodiment, engine 14 may be implemented using at least one of an internal combustion gasoline engine or an internal combustion diesel engine.

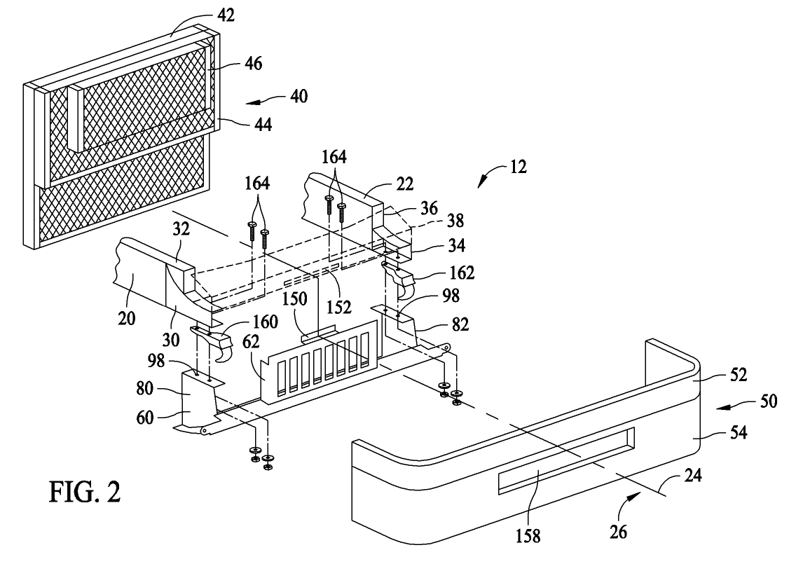

FIG. 2 is an exploded view of a portion of vehicle 10 shown in FIG. 1. As shown in FIG. 2, vehicle 10 also includes a first frame rail 20 and a second frame rail 22 that is disposed approximately parallel to first frame rail 20. As shown in FIG. 2, vehicle 10 includes a centerline axis 24 extends along a length of the vehicle and is utilized to describe the orientation of components coupled to vehicle 10. As used herein a front end 26 of vehicle 10 is located upstream from a rear end 28 of vehicle 10 along centerline axis 24 as shown in FIG. 1. For example, in the exemplary embodiment, engine 14 is positioned on the centerline axis 24 upstream from differential 16 and radiator guard assembly 12 is positioned upstream from engine 14. Accordingly, frame rails 20 and 22 are offset from centerline axis 24 by an approximate equal distance and extend approximately parallel along a length of vehicle 10. In use, frame rails 20 and 22 are used to provide structural support for vehicle 10 and are also utilized to mount various components thereto.

In this embodiment, vehicle 10 also includes a first frame rail extension 30 that is coupled to a forward end 32 of first frame rail 20 and a second frame rail extension 34 that is coupled to a forward end 36 of second frame rail 22. To provide additional structural support, vehicle 10 also includes a front cross-member 38 that is coupled between frame rail extensions 30 and 34 to facilitate maintaining the frame rails 20 and 22 at a relatively fixed distance from each other and to provide additional support to facilitate preventing frame rails 20 and 22 from twisting, etc.

As shown in FIGS. 1 and 2, vehicle 10 also includes a radiator assembly 40 that includes at least a radiator 42 and may also include a charge cooler 44 that is mounted upstream from radiator 42, and an air conditioning condenser 46 that is mounted upstream from charge cooler 44. To facilitate providing protection for vehicle 10, vehicle 10 also includes a bumper assembly 50 that includes at least a front bumper 52 that is typically coupled to frame rails 20 and 22. Bumper assembly 50 may also include a front valence 54 that is coupled to front bumper 52. In the exemplary embodiment, front valence 54 is coupled to a lower surface or lower edge of front bumper 52 and as such extends below front bumper 52 as shown in FIG. 2. Additionally, at least one known vehicle includes a splash guard (not shown) that is coupled to front valence 54 and provides no structural value to the valence.

As discussed above, to improve cooling efficiency, at least some manufacturers have utilized a radiator that has an increased height to increase the cooling capacity. For example, at least some known radiator end caps/tanks are fabricated from a plastic material and, as shown in FIG. 1, extend below a lower surface of front bumper 52. However, as also discussed above, the valence 54 is generally installed to improve the appearance of vehicle 10 and to provide some minimal impact resistance that may be caused by relatively small objects impacting the radiator such as gravel, for example. Therefore, known valences are fabricated utilizing a relatively thin metallic material or more generally using a plastic material that is generally not effective at protecting radiator assembly 40 when vehicle 10 impacts a relatively large object such as a deer, a dog, etc.

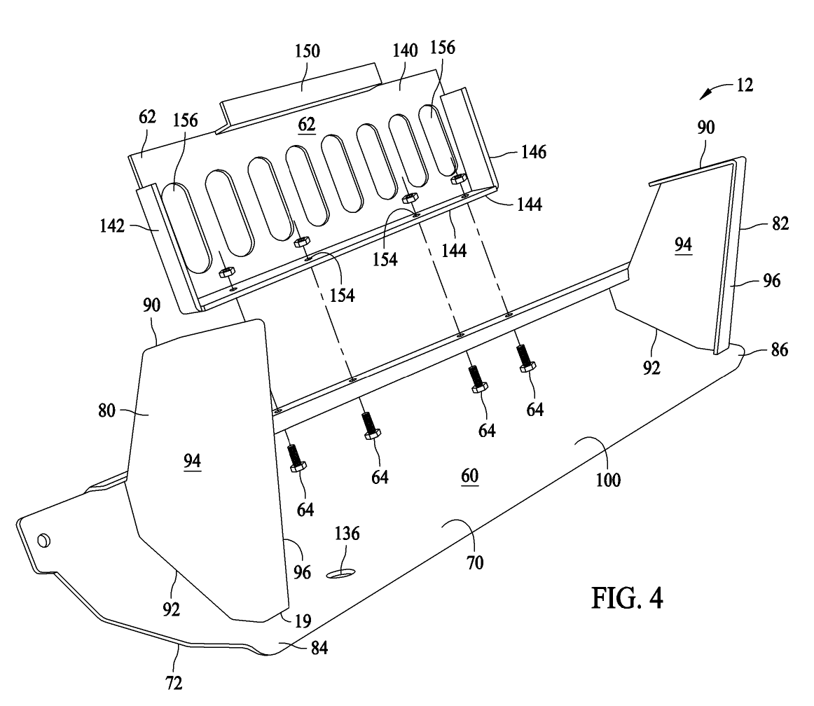

To facilitate reducing damage to radiator assembly 40, vehicle 10 includes the exemplary radiator guard assembly 12. In the exemplary embodiment shown in FIG. 2, radiator guard assembly 12 includes a first portion referred to herein as a radiator guard 60 and a second portion referred to herein as a grill guard 62. In this embodiment, radiator guard 60 and grill guard 62 are fabricated as separate components that are coupled together using a plurality of fasteners 64 (shown in FIG. 4). Optionally, radiator guard 60 and grill guard 62 are fabricated as a single unitary component.

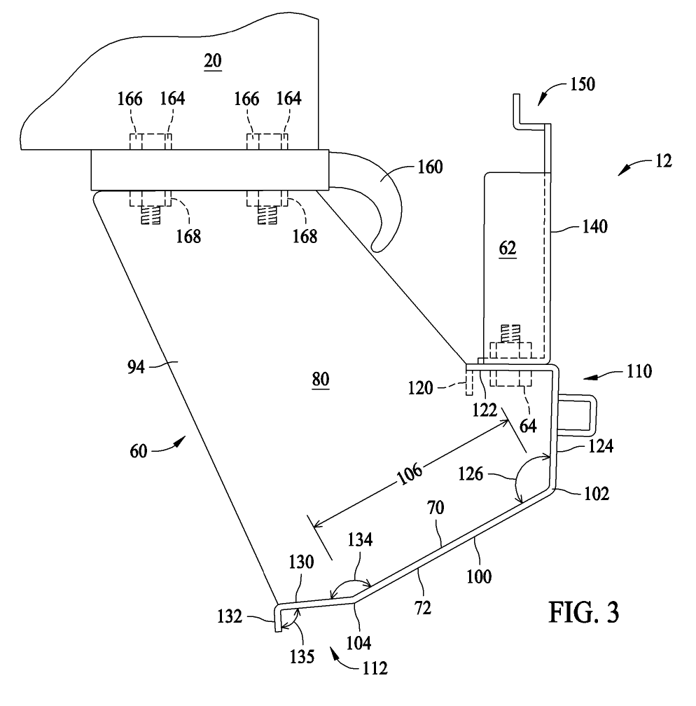

FIG. 3 is side view of radiator guard assembly 12, and FIG. 4 is a perspective view of radiator guard assembly 12 viewed from a rearward direction to a forward direction. As discussed above radiator guard assembly 12 includes radiator guard 60 that has an upper surface 70 and a lower surface 72. More specifically, radiator guard assembly 12 includes a first mounting bracket 80 that is welded to upper surface 70 and a second mounting bracket 82 to is also welded to upper surface 70. First mounting bracket 80 is coupled proximate to a first end 84 of radiator guard 60 and a second mounting bracket 82 is coupled proximate to a second end 86 of radiator guard 60. As shown in FIG. 3, each mounting bracket includes a first end 90 that are each utilized to couple radiator guard assembly 12 to vehicle 10 and a second end 92 that is utilized to couple each respective mounting bracket 80 and 82 to radiator guard 60.

Each mounting bracket 80 and 82 is fabricated to include first end 90, second end 92, a body portion 94, and a back end 96. More specifically, the back end 96 is coupled to body portion 94 such that back end 96 is approximately perpendicular to body portion 94. Shaping the back end 96 to include an approximately ninety degree bend increases the strength of each mounting bracket and thus increases the overall strength of radiator guard assembly 12. Moreover, the first end 90 is coupled to body portion 94 such that the first end 90 is approximately perpendicular to body portion 94.

In the exemplary embodiment, each mounting bracket 80 and 82 is fabricated using a single sheet of metallic material. The metallic material is then bent or formed to include first end 90 and front end 96. Optionally, the first end 90 and front end 96 may be fabricated as separate components and coupled to body portion 94 using a welding or brazing procedure, for example. In the exemplary embodiment, first end 90 has a cross-section profile that is substantially similar to the cross-section profile of a respective frame rail 20 or 22 to enable radiator guard assembly 12 to be coupled to frame rails 20 and 22. Moreover, second end 92 has a cross-sectional profile that is substantially similar to a cross-section profile of upper surface 70 to enable the mounting brackets 80 and 82 to be welded or brazed to radiator guard 60.

Each mounting bracket 80 and 82 also includes a plurality of openings 98, shown in FIG. 2, that are formed through the first end 90 of each respective bracket to enable an operator to couple radiator guard 60 to vehicle 10 as will be discussed below.

Referring again to FIG. 3, in the exemplary embodiment, radiator guard 60 includes a pan 100 having an upstream end 102 and a downstream end 104. Pan 100 has a length 106 that is generally determined based on the width of the overall cooling system 40 installed in vehicle 10. For example, in some known cooling systems those components include (FIG. 1) an increased height radiator 42 and a decreased height air cooler 44 and air conditioning condenser 46 pan length 106 may be reduced. Optionally, a vehicle having a radiator having an increased height, pan length 106 may be increased.

Radiator guard 60 also includes a first pan stabilizer 110 that is coupled to the pan upstream end 102 and a second pan stabilizer 112 that is coupled to the pan downstream end 104. During operation the first pan stabilizer 110 is configured to receive the impact load generated by the vehicle 10 striking an object for example, and transfer the impact load through pan 100 to the second pan stabilizer 112. Moreover, the U-shaped cross-sectional profile facilitates increasing the overall strength of radiator guard 60.

In the exemplary embodiment, the first pan stabilizer 110 includes a first portion 120, a second portion 122 that is substantially perpendicular to the first portion 120 and also forms the upper surface of radiator guard 60, and a third portion 124 that is substantially perpendicular to the second portion 122 and substantially parallel to the first portion 120. As such, and as shown in FIG. 3, the first pan stabilizer 110 has a substantially U-shaped cross-section profile. In the exemplary embodiment, the first pan stabilizer 110 is bent or formed using a single piece of metallic material. Optionally, the first, second, and third portions 120, 122, and 124 may be formed as separate components and coupled together using a welding procedure, for example, to form the first pan stabilizer 110. During assembly, the first pan stabilizer 110 is coupled or formed with pan 100 such that the third portion 124 is offset from pan 100 by an angle 126 that is greater than ninety degrees and less than approximately one hundred and forty-five degrees.

In the exemplary embodiment, second pan stabilizer 112 has a first portion 130 and a second portion 132 that is coupled to first portion 130. As such, and as shown in FIG. 3, the second pan stabilizer 112 has a substantially L-shaped cross-section profile. In the exemplary embodiment, the second pan stabilizer 112 is bent or formed using a single piece of metallic material. Optionally, the first and second portions 130 and 132 may be formed as separate components and coupled together using a welding procedure, for example, to form the second pan stabilizer 112. During assembly, the second pan stabilizer 112 is coupled or formed with pan 100 such that the first portion 130 is offset from pan 100 by an angle 134 that is less than one hundred and eighty degrees and greater than ninety degrees. Moreover, the first portion 130 is coupled to or formed with the second portion 132 such that the first portion 130 is offset from the second portion by an angle 135 that is less than ninety degrees. During operation, the L-shaped cross-sectional profile facilitates increasing the overall strength of radiator guard 60. As shown in FIG. 4, pan 100 also includes an opening 136 that has a diameter that is sized to enable an operator to access a radiator drain plug (not shown) to perform maintenance, service, etc.

In the exemplary embodiment, radiator guard 60, first bracket 80 and second bracket 82 are each fabricated utilizing an aluminum material. Utilizing aluminum facilitates increasing the strength of the radiator guard assembly 12 while minimizing the additional weight installed on vehicle 10. In the exemplary embodiment, radiator guard 60 is fabricated utilizing aluminum plate that has a thickness of between approximately 3/16 of an inch and approximately 5/16 of inch, such that during operation, the radiator guard at least partially collapses during a severe impact with larger objects to substantially inhibit progressive damage to the frame or extensions. Additionally, in the exemplary embodiment, the pan is fabricated using a substantially solid piece of material such that the pan does not include a plurality of openings or slots extending therethrough for either cooling purposes thus increasing the structural strength of the pan 100. Optionally, pan 100 may include cooling openings extending therethrough.

As shown in FIGS. 1-4, radiator guard assembly 12 also includes the grill guard 62. As shown in FIGS. 3 and 4, grill guard 62 includes a front plate 140, a first side 142, a second side 144 that is substantially perpendicular to first side 142, and a third side 146 that is substantially perpendicular to second side 144 and also substantially parallel to first side 142. In the exemplary embodiment, first side 142, second side 144 and third side 146 are formed unitarily with front plate 140. More specifically, in the exemplary embodiment, during fabrication, a single piece of metallic material, such as aluminum, is bent or formed to define the front plate 140 and the first, second, and third sides, respectively. The respective sides are then joined at their respective ends using a welding procedure for example, to increase the overall strength of the grill guard 62. Additionally, in the exemplary embodiment, the first, second, and third sides 142, 144, and 146 are offset from the front plate 140 at an angle that is approximately ninety degrees.

Grill guard 62 further includes an attachment apparatus or tab 150 that in the exemplary embodiment is coupled to front plate 140 using a welding or brazing procedure for example. Optionally, tab 150 may be formed unitarily with front plate 140. As shown in FIG. 3, tab 150 has a substantially L-shaped cross-sectional profile to enable at least a portion of tab 150 to be inserted through an opening 152 defined in front cross-member 38. Grill guard 62 also includes a plurality of openings 154 that extend through second side 144, i.e. the lower surface of grill guard 62, to enable grill guard 62 to be coupled to radiator guard 60 using fasteners 64. Moreover, grill guard 62 includes a plurality of openings 156 that are formed through front plate 140. More specifically, as shown in FIG. 2, front valence 54 includes at least one opening 158 defined therethrough. As such, to facilitate cooling air that is channeled through the valence opening 158 to be further channeled to radiator assembly 40, a sufficient quantity of cooling openings 156 are formed through front plate 140 to enable substantially unrestricted airflow to the radiator assembly. In the exemplary embodiment, the cooling openings 156 having a substantially oval shape. Moreover, as shown in FIG. 4, utilizing a plurality of cooling openings 156 facilitates maintaining the structural integrity of grill guard 62 to enable grill guard 62 to substantially prevent objects passing through the valence opening 158 from damaging the radiator assembly 40 and add additional strength to the second portion 122 of the stabilizer 110.

In the exemplary embodiment, to couple grill guard assembly 12 to vehicle 10, an operator or maintenance person, installs the radiator guard assembly by coupling to three attachment points. For example, as shown in FIGS. 2 and 3, in the exemplary embodiment, vehicle 10 includes a first tow hook 160 that is coupled to frame extension 30 and a second tow hook 162 that is coupled to frame extension 34. Each tow hook 160 and 162 is coupled to each respective frame rail using at least two fasteners 164 that generally each include a bolt 166 and a nut 168.

During assembly, the operator removes the nut 168 from each respective bolt 166 and positions mounting bracket 80 proximate to frame extension 30 and mounting bracket 82 proximate to frame extension 34. The radiator guard assembly 12 in then lifted into position such that the respective bolts 166 extend through the openings 98, that are formed through the first end 90 of each respective bracket 80 and 82. Approximately simultaneously, the radiator guard assembly is maneuvered to enable tab 150 to be inserted through the opening 152 defined in front cross-member 38. After tab 150 is inserted into opening 152 to secure grill guard 62 is a substantially fixed position, nuts 168 are recoupled to each respective bolt 162 to secure the radiator guard assembly 12 to vehicle 10.

In this configuration, grill guard 62 is positioned upstream from radiator assembly 40 and downstream from bumper assembly 50. Moreover, radiator guard 60 substantially covers the lower surface area of radiator assembly 40 to facilitate preventing damage from occurring to radiator assembly 40.

More specifically, during operation, as discussed above, when the vehicle strikes an object, the force of the object causes the first pan stabilizer to absorb a portion of the load and transfer the remaining load through the pan to the second stabilizer wherein the remaining portion of the load is absorbed. As such, during operation, the front and rear stabilizers are each configured to partially flex or bend to absorb the load when a object of sufficient size and/or weight causes a frontal impact to the vehicle while preventing or causing the radiator guard to strike the radiator. Additionally, the pan configuration enables objects to be deflected downward toward the road and away from the radiator.

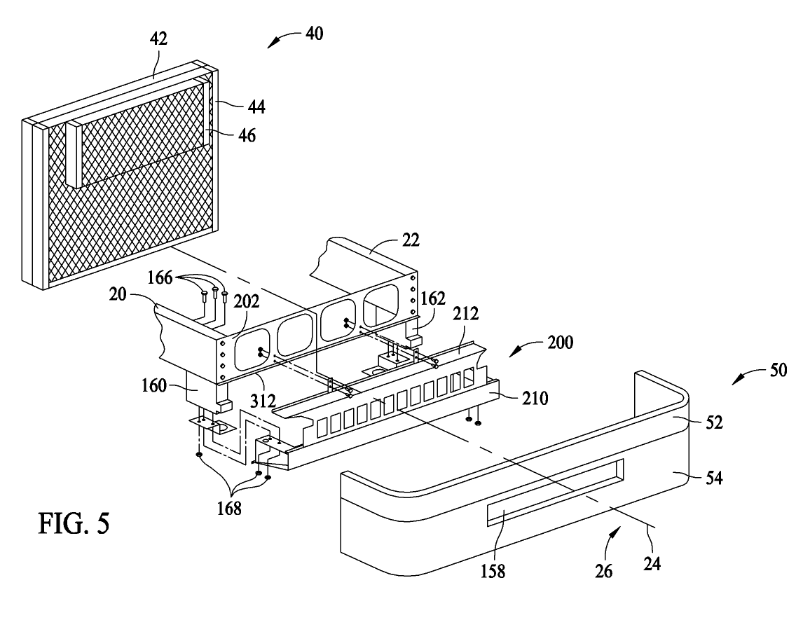

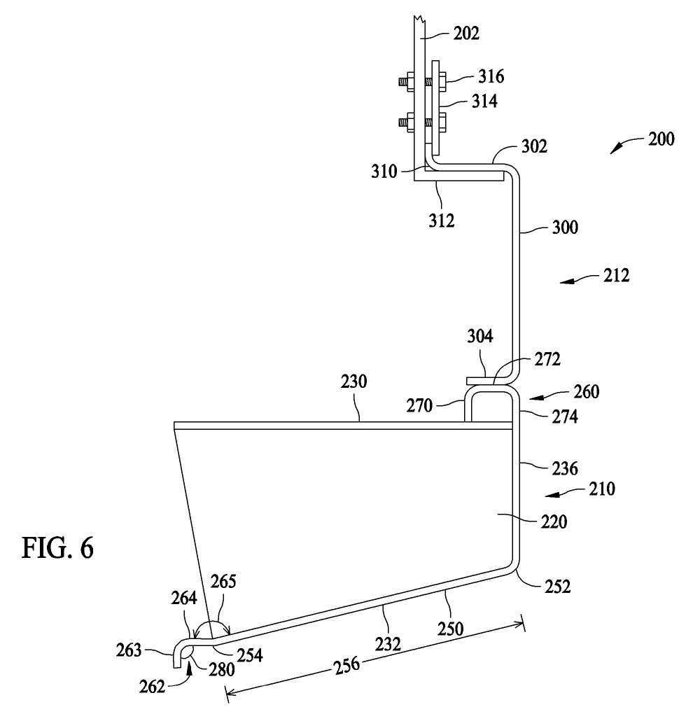

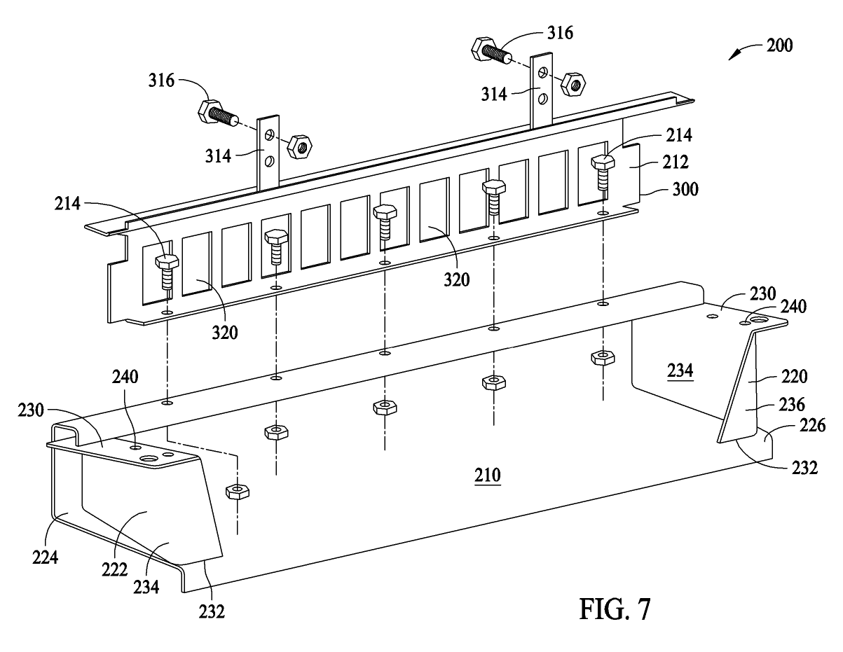

FIG. 5 is an exploded view of a portion of vehicle 10 shown in FIG. 1 that includes another exemplary radiator guard assembly 200. FIG. 6 is a side view of radiator guard assembly 200. FIG. 7 is a back rear facing forward perspective view of radiator guard assembly 200. In this embodiment, vehicle 10 does not include frame rail extensions, rather to provide additional structural support, vehicle 10 also includes a front cross-member 202 that is coupled between frame rails 20 and 22 to facilitate maintaining the frame rails 20 and 22 at a relatively fixed distance from each other and to provide additional support to facilitate preventing frame rails 20 and 22 from twisting, etc.

As shown in FIG. 5, vehicle 10 also includes a radiator assembly 40 and bumper assembly 50, as shown in FIGS. 1-4. In the exemplary embodiment shown in FIG. 5, radiator guard assembly 200 includes a first portion referred to herein as a radiator guard 210 and a second portion referred to herein as a grill guard 212. In this embodiment, radiator guard 210 and grill guard 212 are fabricated as separate components that are coupled together using a plurality of fasteners 214 (shown in FIG. 7). Optionally, radiator guard 210 and grill guard 212 are fabricated as a single unitary component.

As discussed above radiator guard assembly 200 includes radiator guard 210 includes a first mounting bracket 220 and a second mounting bracket 222. First mounting bracket 220 is coupled proximate to a first end 226 of radiator guard 210 and a second mounting bracket 222 is coupled proximate to a second end 224 of radiator guard 210. As shown in FIGS. 5 and 7, each mounting bracket includes a first end 230 that are each utilized to couple radiator guard assembly 200 to vehicle 10 and a second end 232 that is utilized to couple each respective mounting bracket 220 and 222 to radiator guard 210.

Each mounting bracket 220 and 222 is fabricated to include first end 230, second end 232, a body portion 234, and a back end 236. More specifically, the back end 236 is coupled to body portion 234 such that back end 236 is approximately perpendicular to body portion 234. Shaping the back end 236 to include an approximately ninety degree bend increases the strength of each mounting bracket and thus increases the overall strength of radiator guard assembly 200. Moreover, the first end 230 is coupled to body portion 234 such that the first end 230 is approximately perpendicular to body portion 234.

In the exemplary embodiment, each mounting bracket 220 and 222 is fabricated using a single sheet of metallic material. The metallic material is then bent or formed to include first end 230 and back end 236. Optionally, the first end 230 and back end 236 may be fabricated as separate components and coupled to body portion 234 using a welding or brazing procedure, for example. In the exemplary embodiment, first end 230 has a cross-section profile that is substantially similar to the cross-section profile of a respective frame rail 20 or 22 to enable radiator guard assembly 200 to be coupled to frame rails 20 and 22. Moreover, second end 232 has a cross-sectional profile that is substantially similar to a cross-section profile of an upper surface 238 of radiator guard 210 to enable the mounting brackets 220 and 222 to be welded or brazed to radiator guard 210.

Each mounting bracket 220 and 222 also includes a plurality of openings 240, shown in FIG. 7, that are formed through the first end 230 of each respective bracket to enable an operator to couple radiator guard 210 to vehicle 10 as will be discussed below.

Referring again to FIG. 6, in the exemplary embodiment, radiator guard 210 includes a pan 250 having an upstream end 252 and a downstream end 254. Pan 250 has a length 256 that is generally determined based on the overall width of the cooling system 40 installed in vehicle 10. For example, in a vehicle having an increased height radiator 42 and an increased height air cooler 44 pan length 256 may be increased. Optionally, a vehicle having a radiator having an increased height and an air cooler with decreased height, pan length 256 may be reduced.

Radiator guard 210 also includes a first pan stabilizer 260 that is coupled to the pan upstream end 252 and a second pan stabilizer 262 that is coupled to the pan downstream end 254. In the exemplary embodiment, pan stabilizers 260 and 262 are formed unitarily with pan 250. During operation the first pan stabilizer 260 is configured to receive the impact load generated by the vehicle 10 striking an object for example, and transfer the impact load through pan 250 to the second pan stabilizer 262. Moreover, the U-shaped cross-sectional profile of first pan stabilizer 260, facilitates increasing the overall strength of radiator guard 210.

In the exemplary embodiment, the first pan stabilizer 260 includes a first portion 270, a second portion 272 that is substantially perpendicular to the first portion 270 and also forms the upper surface of radiator guard 210, and a third portion 274 that is substantially perpendicular to the second portion 272 and substantially parallel to the first portion 270. As such, and as shown in FIG. 6, the first pan stabilizer 260 has a substantially U-shaped cross-section profile and forms the forward face of pan 250. In the exemplary embodiment, the first pan stabilizer 260 is bent or formed using a single piece of metallic material. Optionally, the first, second, and third portions 270, 272, and 274 may be formed as separate components and coupled together using a welding procedure, for example, to form the first pan stabilizer 260.

In the exemplary embodiment, second pan stabilizer 262 is coupled to or formed unitarily with pan 250. As such, and as shown in FIG. 6, the second pan stabilizer 262 has a substantially L-shaped cross-section profile. In the exemplary embodiment, the second pan stabilizer 262 is bent or formed using a single piece of metallic material. During assembly, the second pan stabilizer 262 is coupled or formed with pan 250 such that first portion 264 is offset from pan 250 by an angle 265 that is less than one hundred and eighty degrees and greater than ninety degrees. Moreover, the first portion 264 is coupled to or formed with the second portion 263 such that the first portion 264 is offset from the second portion by an angle 280 that is less than ninety degrees. During operation, the L-shaped cross-sectional profile of second pan stabilizer 262 facilitates increasing the overall strength of radiator guard 210.

In the exemplary embodiment, radiator guard 210, first bracket 220 and second bracket 222 are each fabricated utilizing an aluminum material. Utilizing aluminum facilitates increasing the strength of the radiator guard assembly 200 while minimizing the additional weight installed on vehicle 10. In the exemplary embodiment, radiator guard 210 is fabricated utilizing aluminum plate that has a thickness of between approximately 3/16 of an inch and approximately 5/16 of inch.

As shown in FIGS. 6-7, radiator guard assembly 200 also includes the grill guard 212. Grill guard 212 includes a front plate 300, a first side 302, and a second side 304 that is substantially perpendicular to first side 302. In the exemplary embodiment, first side 302 and second side 304 are formed unitarily with front plate 300. More specifically, in the exemplary embodiment, during fabrication, a single piece of metallic material, such as aluminum, is bent or formed to define the front plate 300, first side 302, and second side 304, respectively. Additionally, in the exemplary embodiment, the first side 302 and second side 304 are offset from the front plate 300 at an angle that is approximately ninety degrees.

Grill guard 212 further includes an attachment apparatus or a mounting flange 310 to enable the grill guard to be secured to the front cross-member 202. More specifically, as shown in FIGS. 5, grill guard mounting flange 310 is configured to cooperate with a tab 312 that extends approximately perpendicular from and is formed with front cross-member 202 to facilitate securing the grill guard 212 and thus radiator guard 210 to the vehicle 10. Moreover, grill guard 212 also includes a plurality of straps 314 that are formed with or welded to grill guard 212 and utilized to couple further couple grill guard 212 to cross-member 202 utilizing a plurality of fasteners 316. Moreover, grill guard 212 includes a plurality of openings 320 that are formed through front plate 300. More specifically, as shown in FIG. 2, front valence 54 includes at least one opening 158 defined therethrough. As such, to facilitate cooling air that is channeled through the valence opening 158 to be further channeled to radiator assembly 40, a sufficient quantity of cooling openings 320 are formed through front plate 300 to enable substantially unrestricted airflow to the radiator assembly. In the exemplary embodiment, the cooling openings 320 have a substantially rectangle shape. Moreover, as shown in FIG. 5, utilizing a plurality of cooling openings 320 facilitates maintaining the structural integrity of grill guard 212 to enable grill guard 212 to substantially prevent objects passing through the valence opening 158 from damaging the radiator assembly 40.

In the exemplary embodiment, to couple grill guard assembly 200 to vehicle 10, an operator or maintenance person, installs the radiator guard assembly 210 by coupling to three attachment points. For example, as shown in FIGS. 5 and 7, in the exemplary embodiment, vehicle 10 includes a first tow hook 160 that is coupled to frame rail 20 and a second tow hook 162 that is coupled to frame rail 22. Each tow hook 160 and 162 is coupled to each respective frame rail using at least three fasteners 164 that generally each include a bolt 166 and a nut 168.

During assembly, the operator removes the nut 168 from only two respective bolts 166 and positions mounting bracket 220 proximate to frame rail 20 and mounting bracket 222 proximate to frame rail 22. The radiator guard assembly 200 is then lifted into position such that the respective bolts 166 extend through the openings 240, that are formed through the first end 230 of each respective bracket 220 and 222. As such, since each tow hook includes at least three bolts securing each tow hook to a respective frame rail, the tow hooks 160 and 162 do not need to be completely removed to install radiator guard assembly 200. Approximately simultaneously, the radiator guard assembly is maneuvered to enable mounting flange 310 to be positioned above tab 312 defined in front cross-member 38. After the mounting flange 310 is positioned with respect to tab 312, bolts 316 are then inserted through straps 314 to couple grill guard 212 to cross-member 202 and thus secure the radiator guard assembly 200 to vehicle 10.

In this configuration, grill guard 212 is positioned upstream from radiator assembly 40 and downstream from bumper assembly 50. Moreover, radiator guard 210 substantially covers the lower surface area of radiator assembly 40 to facilitate preventing damage from occurring to radiator assembly 40.

More specifically, during operation, as discussed above, when the vehicle strikes an object, the force of the object causes the first pan stabilizer to absorb a portion of the load and transfer the remaining load through the pan to the second stabilizer wherein the remaining portion of the load is absorbed. As such, during operation, the front and rear stabilizers are each configured to partially flex or bend to absorb the load when a object of sufficient size and/or weight causes a frontal impact to the vehicle while preventing or causing the radiator guard to strike the radiator. Additionally, the pan configuration enables objects to be deflected downward toward the road and away from the radiator.

While the invention has been described in terms of various specific embodiments, those skilled in the art will recognize that the invention can be practiced with modification within the spirit and scope of the claims.

What is claimed is:

1. A radiator guard assembly for a vehicle that includes a first frame rail, a second frame rail, a bumper assembly coupled to the first and second frame rails, and a radiator coupled to the first and second frame rails, said radiator guard assembly comprising:
a radiator guard; and
a pair of mounting brackets for coupling said radiator guard to the first and second frame rails axially downstream from the bumper, said radiator guard configured to substantially prevent an object from undesirably contacting the radiator.

2. A radiator guard assembly in accordance with claim 1 wherein said pair of mounting brackets are formed unitarily with said radiator guard.

3. A radiator guard assembly in accordance with claim 1 further comprising a grill guard that is coupled to said radiator guard, at least a portion of said grill guard is positioned upstream from the radiator and downstream from the bumper assembly.

4. A radiator guard assembly in accordance with claim 1 wherein said radiator guard comprises:
a pan having an upstream end and a downstream end;
a first pan stabilizer coupled to said pan upstream end; and
a second pan stabilizer coupled to said pan downstream end, said first pan stabilizer configured to receive an impact load and transfer the impact load through said pan to said second pan stabilizer.

5. A radiator guard assembly in accordance claim 1 wherein said vehicle further comprises a front cross-member having an opening defined therethrough, the front cross-member is coupled between the first and second frame rails, said grill guard comprises a tab portion configured to extend at least partially through said opening to facilitate securing said radiator guard assembly to the vehicle.

6. A radiator guard assembly in accordance claim 1 wherein said vehicle further comprises a front cross-member comprising a mounting flange, the front cross-member is coupled between the first and second frame rails, said grill guard comprises a tab portion configured to cooperate with said mounting flange to facilitate securing said radiator guard assembly to the vehicle.

7. A radiator guard assembly in accordance with claim 3 wherein the bumper assembly comprises a front bumper and a valence having at least one opening extending therethrough, the valence is coupled to a lower surface of the bumper, said grill guard comprises a plurality of openings extending therethrough, at least a portion of said grill guard openings in flow communication with the valence opening.

8. A radiator guard assembly in accordance with claim 1 wherein the radiator includes a drain plug, said radiator guard assembly further comprises an opening extending therethrough that is substantially aligned with the drain plug.

9. A radiator guard assembly in accordance with claim 1 wherein said radiator guard assembly comprises an aluminum material.

10. A method for preventing damage to a vehicle radiator, said method comprising:
coupling a radiator guard to a first frame rail and a second frame rail such that radiator guard substantially covers at least a portion of the front and lower surface of the vehicle radiator to substantially prevent an object from undesirably contacting the radiator; and
coupling a grill guard to the radiator guard.

11. A method in accordance with claim 10 wherein coupling the grill guard to the radiator guard further comprises coupling the grill guard to the radiator guard such that at least a portion of the grill guard is positioned upstream from the vehicle radiator and downstream from a bumper assembly that is coupled to the first and second frame rails.

12. A method in accordance with claim 10 wherein coupling a radiator guard further comprises coupling a radiator guard including a pan having an upstream end and a downstream end, a first pan stabilizer coupled to the pan upstream end, and a second pan stabilizer coupled to the pan downstream end to the first and second frame rails such that the first pan stabilizer configured to receive an impact load and transfer the impact load through the pan to the second pan stabilizer.

13. A method in accordance with claim 10 wherein the vehicle further comprises a front cross-member having an opening defined therethrough, the front cross-member is coupled between the first and second frame rails and said grill guard comprises a tab portion, said method further comprising inserting the grill guard tab at least partially through the front cross-member opening to facilitate securing the grill guard to the vehicle.

14. A vehicle comprising:
a first frame rail;
a second frame rail;
a bumper assembly coupled to said first and second frame rails; and
a radiator coupled to said first and second frame rails, said radiator guard assembly comprising
a radiator guard; and
a pair of mounting brackets for coupling said radiator guard to the first and second frame rails axially downstream from the bumper, said radiator guard configured to substantially prevent an object from undesirably contacting the radiator.

15. A vehicle in accordance with claim 14, wherein said pair of mounting brackets are formed unitarily with said radiator guard.

16. A vehicle in accordance with claim 14 wherein said radiator guard assembly further comprises a grill guard that is coupled to said radiator guard, at least a portion of said grill guard is positioned upstream from the radiator and downstream from the bumper assembly.

17. A vehicle in accordance with claim 14 wherein said radiator guard assembly further comprises:
a pan having an upstream end and a downstream end;
a first pan stabilizer coupled to said pan upstream end; and
a second pan stabilizer coupled to said pan downstream end, said first pan stabilizer configured to receive an impact load and transfer the impact load through said pan to said second pan stabilizer.

18. A vehicle in accordance with claim 14 wherein said vehicle further comprises a front cross-member having an opening defined therethrough, said front cross-member is coupled between said first and second frame rails, said grill guard further comprises a tab portion configured to extend at least partially through said opening to facilitate securing said radiator guard assembly to the vehicle.

19. A vehicle in accordance with claim 14 wherein said vehicle further comprises a front cross-member comprising a mounting flange, said front cross-member is coupled between said first and second frame rails, said grill guard further comprises a tab portion configured to cooperate with said mounting flange to facilitate securing said radiator guard assembly to said vehicle.

20. A vehicle in accordance with claim 14 wherein said bumper assembly comprises a front bumper and a valence having at least one opening extending therethrough, said valence is coupled to a lower surface of said bumper, said grill guard comprises a plurality of openings extending therethrough, at least a portion of said grill guard openings in flow communication with said valence opening.
